(19) United States
(12) Patent Application Publication
(10) Pub. No.: US 2011/0302195 A1
(43) Pub. Date: Dec. 8, 2011

(54) Multi-Versioning Mechanism for Update of Hierarchically Structured Documents Based on Record Storage

(75) Inventors: Mengchu Cai, San Jose, CA (US); Eric N. Katayama, San Jose, CA (US); Guogen Zhang, San Jose, CA (US); Shirley Zhou, Fremont, CA (US)

(73) Assignee: INTERNATIONAL BUSINESS MACHINES CORPORATION, Armonk, NY (US)

(21) Appl. No.: 12/796,599

(22) Filed: Jun. 8, 2010

(51) Int. Cl. G06F 17/30

(52) U.S. Cl. 707/769; 707/802; 707/E17.005; 707/E17.014

(57) ABSTRACT

A method for multi-versioning data of a hierarchically structured document stored in data records includes: changing document data in one or more data records, each data record assigned a record identifier, the data record including a plurality of nodes assigned a node identifier, and the document assigned a document identifier; storing an update timestamp in a base table row referencing the document identifier; storing in each changed data record a start timestamp for a start of a validity period for the changed data record and an end timestamp for an end of the validity period; and storing the start timestamp and the end timestamp in one or more node identifier index entries referencing the document identifier, the record identifier, and the node identifier. A version of the document may be obtained using node identifier index entries satisfying a version timestamp.

### BACKGROUND

A relational database management system may support the ability to store hierarchically structured documents, such as extensible markup language (XML) documents, natively as columns within relational tables. The relational objects are stored in rows of a base table. The relational objects do not contain the XML data itself, but instead contain the unique XML Document Identifier, called a “Doc ID” herein. The Doc ID is unique across a table. The XML document is stored as XML data nodes, usually in sub-trees, in XML records assigned unique record identifiers (RID). The XML records are stored separately from the base table. The Doc ID stored in the base table is used to refer to the XML records, and links between the XML records are through a Node ID index, which references the Doc ID mapped to the unique Node ID's assigned to the XML data nodes and the RID's of the XML records.

Keeping versions of an XML document after an update of any portion of the XML document may be useful. For applications that tend to have a high volume of concurrent readers, keeping multiple versions of an XML document during update so that the readers can still read the old version without waiting may be important. Multi-versioning can also help provide snapshot semantics and the ability to select from old data.

One approach is to store a version of the whole XML document each time the XML document is modified. However, this approach is inefficient in terms of storage space and time, especially when a large number of sub-document updates occur.

### BRIEF SUMMARY

According to one embodiment of the present invention, a method for multi-versioning data of a hierarchically structured document stored in a plurality of data records of a relational database system, comprises: changing document data in one or more data records of the plurality of data records, each data record assigned a record identifier, the data record comprising a plurality of nodes assigned a node identifier, and the hierarchically structured document assigned a document identifier; storing an update timestamp in a base table row referencing the document identifier; storing in each changed data record a start timestamp for a start of a validity period for the changed data record and an end timestamp for an end of the validity period; and storing the start timestamp and the end timestamp in one or more node identifier index entries referencing the document identifier, the record identifier, and the node identifier.

In one aspect of the embodiment of the present invention, the one or more data records are inserted into the plurality of data records: where a current timestamp comprising a time of the inserting is stored in the base table row referencing the document identifier; where the current timestamp is stored in each inserted data record as the start timestamp and a large value is stored as the end timestamp; and where the current timestamp is stored as the start timestamp and the large value is stored as the end timestamp in the one or more node identifier index entries referencing the document identifier, the record identifier, and the node identifier.

In another aspect of the embodiment of the present invention, the one or more data records of the plurality of data records is updated: where a current timestamp comprising a time of the updating is stored in the base table row referencing the document identifier; where for each data record replaced in the updating, the current timestamp is stored in the replaced data record as the end timestamp, and for each replacement data record in the updating, the current timestamp is stored in the replacement data record as the start timestamp and a large value as the end timestamp; and where for each data record replaced in the updating, the current timestamp is stored as the end timestamp in the one or more node identifier index entries referencing the document identifier, a record identifier assigned to the replaced data record, and a node identifier assigned to the replaced data record, and for each replacement data record in the updating, one or more new node identifier index entries referencing the document identifier, a record identifier assigned to the replacement data record, and a node identifier assigned to the replacement data record are inserted, and the current timestamp is stored as a start timestamp and the large value as an end timestamp in the one or more new node identifier index entries.

In another aspect of the embodiment of the present invention, the hierarchically structured document is deleted: where the base table row referencing the document identifier is deleted; where a current timestamp comprising a time of the deleting as the end timestamp is stored in each data record of the deleted hierarchically structured document; and where the current timestamp is stored as the end timestamp in the one or more node identifier index entries for each data record of the deleted hierarchically structured document.

In another aspect of the embodiment of the present invention, a query to select a version of the hierarchically structured document is received, the query comprising the document identifier and a version timestamp; the node identifier index is searched for one or more entries referencing the document identifier and the node identifier, and where the start timestamp of the entry is less than or equal to the version timestamp and the end timestamp of the entry is greater than the version timestamp; one or more data records for the version of the hierarchically structured document are found using the found node identifier entries; and the obtained data records are returned.

In one aspect of the embodiment of the present invention, the version timestamp is obtained from the update timestamp in the base table row referencing the document identifier.

In another aspect of the embodiment of the present invention, the version timestamp is obtained from a timestamp for the query.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system implementing a method of the present invention.

FIG. 2 illustrates an embodiment of the storage structures for the method of the present invention.

FIG. 3 is a flowchart illustrating an embodiment of the method of the present invention.

FIG. 4 is a flowchart illustrating in more details the embodiment of the method of the present invention.

FIGS. 5A and 5B illustrate examples of an insert operation of an embodiment of the present invention.

FIGS. 6A-6D illustrate examples of an update operation of an embodiment of the present invention.

FIG. 6E illustrates an example of a delete operation of an embodiment of the present invention.

FIG. 7 is a flowchart illustrating a select operation to obtain a version of an XML document of an embodiment of the present invention.

FIGS. 8A-8D illustrate an example of the select operation of an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

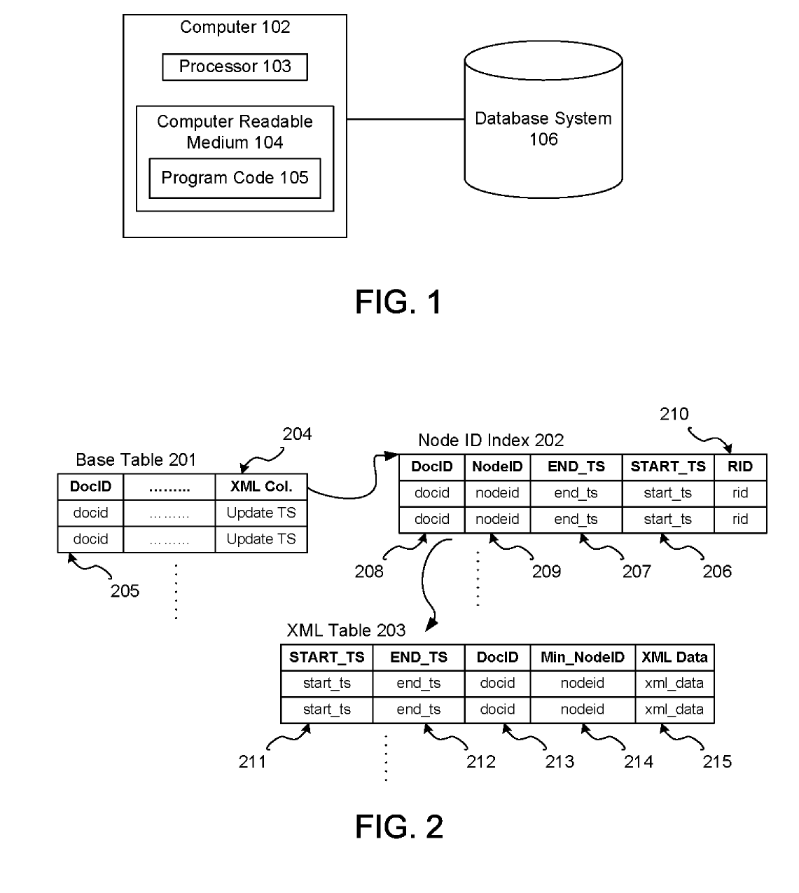

FIG. 1 illustrates an embodiment of a system implementing a method of the present invention. The system includes a computer 102 which is operationally coupled to a processor 103 and a computer readable medium 104. The computer readable medium 104 stores computer readable program code 105 for implementing embodiments of a method of the present invention. The processor 103 executes the program code 105 to provide multi-versioning for updates of hierarchically structured documents according to the various embodiments of the present invention. The method of the present invention will be described below in the context of XML documents, however, one of ordinary skill in the art will understand that the method may be applied to other types of hierarchically structured documents as well without departing from the spirit and scope of the present invention.

FIG. 2 illustrates an embodiment of the storage structures for the method of the present invention. In this embodiment, each row of the base table 201 contains an XML indicator column 204 which contains an update timestamp and a Doc ID column 205. The update timestamp 204 indicates the time of the last update to the XML document identified by the Doc ID 205. Each entry in the Node ID Index 202 contains a start timestamp 206, an end timestamp 207, a Doc ID 208, a Node ID 209 for an XML record, and an RID 210 for the record containing the node identified by the Node ID 209. The start and end timestamps 206-207 indicate the validity time period for the XML record referenced by the index entry. Each row in the XML table 203 contains a start timestamp 211, an end timestamp 212 for XML data 215, a Doc ID 213, and a minimum node ID 214 (node ID for the root node of the subtree). The start and end timestamps 211-212 indicate the validity time period for the XML record.

In this embodiment, the Node ID index entries are sorted in descending order of the start and end timestamps 206-207, so that the more current version of the XML record is listed before the older versions of the XML record. Since the most recent data are typically accessed more frequently, the sorting of the index entries by timestamps avoids significant impact on system performance due to the multi-versioning method of the present invention.

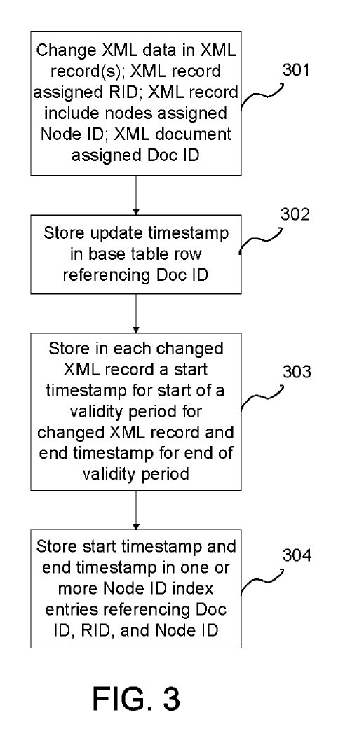

FIG. 3 is a flowchart illustrating an embodiment of the method of the present invention. Referring to both FIGS. 2 and 3, a change to XML data in one or more XML records of an XML document occurs (301), where each changed XML record is assigned a unique record ID (RID), each record including a plurality of nodes assigned a Node ID, and the XML document is assigned a unique Doc ID. An update timestamp 204 is stored in the in the base table row referencing the Doc ID (302). A start timestamp 211 for a start of a validity period for the changed XML record and an end timestamp 212 for the end of the validity period are stored in each changed XML record (303). A start timestamp 206 and an end timestamp 207 are stored in one or more Node ID index entries referencing the Doc ID, the RID, and the Node ID (304). In this embodiment, more than one Node ID index entry may be generated with the same Doc ID and RID, if another record contains a subtree of a node contained in a record. These Node ID index entries would also have the same timestamps. The timestamps (206-207, 211-212) can be the physical clock timestamp, a log record sequence number, or log relative byte address used to sequence events in a system. The validity period indicated by the start timestamps (206, 211) and end timestamps (207, 212) is used to define a version of the XML document identified by the Doc ID, as described further below.

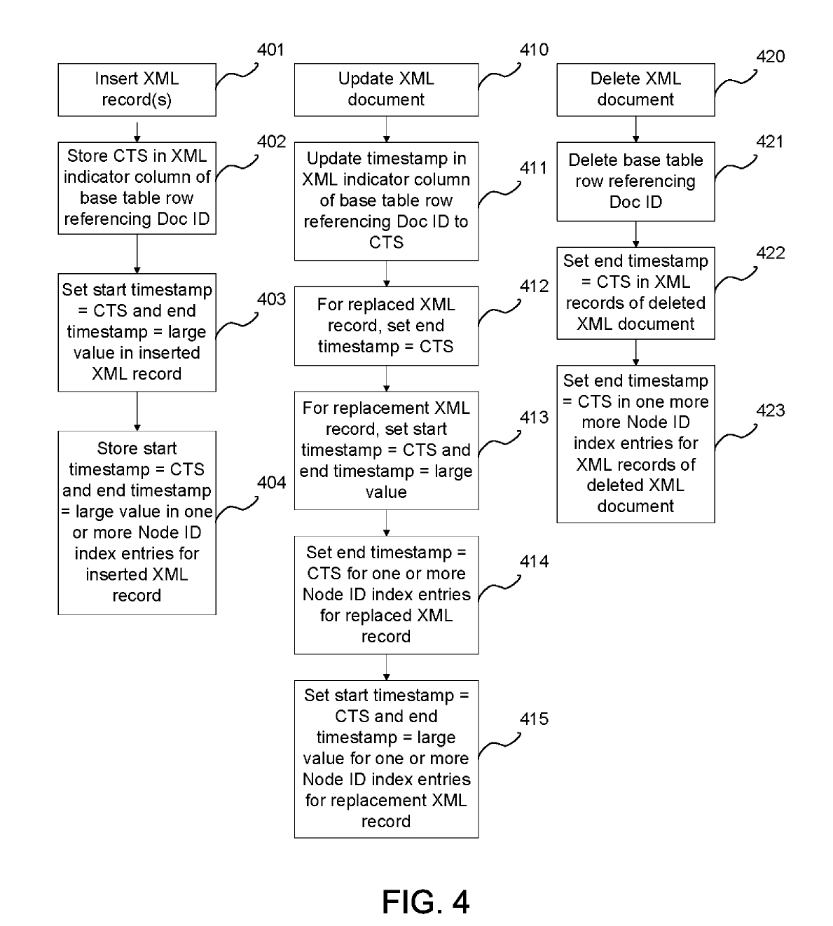

FIG. 4 is a flowchart illustrating in more details the embodiment of the method of the present invention. Three types of operations may be made to the XML document to change XML data: an insert of one or more XML records, an update of an XML document, and a delete of an XML document. When the change to the XML document involves an insert of one or more XML records (401), the method stores a current timestamp (CTS) in the XML indicator column 204 of the base table row referencing the Doc ID of the XML document (402). In this embodiment, the CTS is the time of the insert operation. In the inserted XML record, the method sets the start timestamp 211 to CTS and the end timestamp 212 to a large value, effectively representing infinity (403). One or more new entries for the inserted XML record are generated in the Node ID index 202. The method sets the start timestamp 206 in these index entries to CTS and the end timestamp 207 to a large value (404). Thus, the validity period for the inserted XML record is defined to be from CTS to a time far into the future.

When the change to the XML document involves an update of the XML document (410), which may be considered a replacement of existing XML record(s) with new XML record(s), the method sets the update timestamp 204 in the XML indicator column of the base table row referencing the Doc ID of the XML document to CTS (411). In this embodiment, the CTS is the time of the update operation. For the replaced XML record, the method sets the end timestamp 212 to CTS (412). For the replacement XML record, the method sets the start timestamp 211 to CTS and the end timestamp 212 to a large value (413). For the Node ID index entries for the replaced XML record, the method sets the end timestamp 207 to CTS (414). For the Node ID index entries for the replacement XML record, the method sets the start timestamp 206 to CTS and the end timestamp 207 to a large value (415). Thus, the validity period for the replaced XML record is defined to be from its existing start timestamp to CTS, while the validity period for the replacement XML record is defined to be from CTS to a time far into the future.

When an XML document is deleted (420), the method deletes the base table row referencing the Doc ID of the XML document (421). The method sets the end timestamp 212 in the XML records of the deleted XML document to CTS (422), and sets the end timestamp 207 in the Node ID index entries for the XML records of the deleted XML document to CTS (423). In this embodiment, the CTS is the time of the delete operation. Thus, the validity period for the deleted XML records is defined to be from the existing start timestamps to CTS.

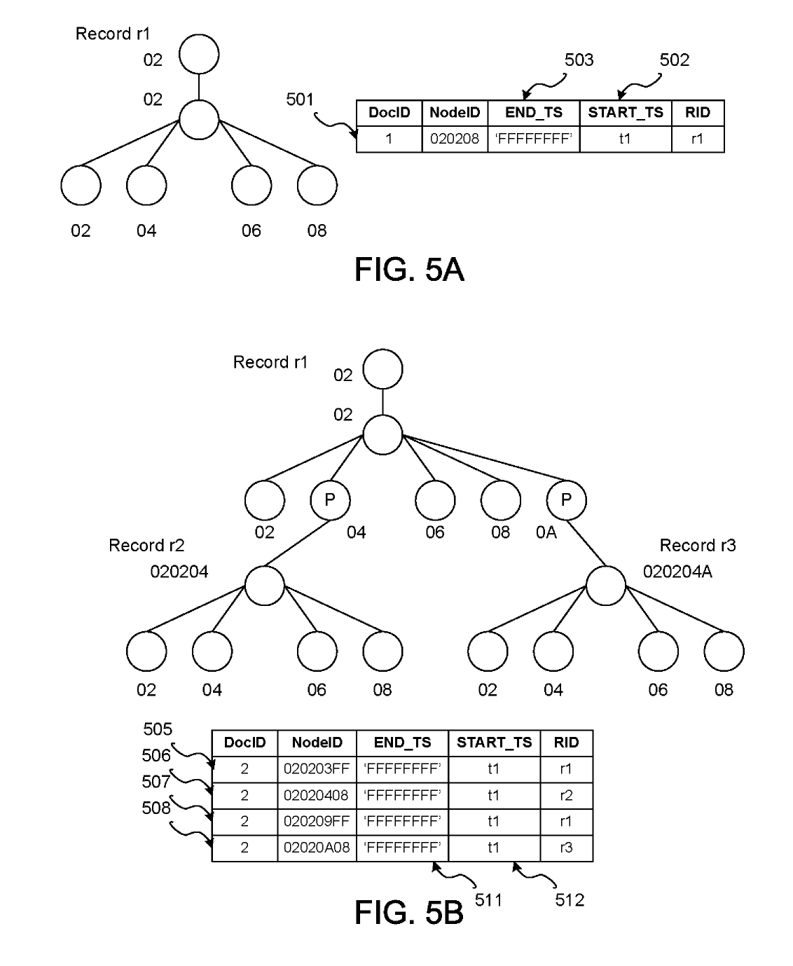

FIGS. 5A and 5B illustrate examples of an insert operation of an embodiment of the present invention. Referring to both FIGS. 4 and 5A, an XML document with Doc ID=1, a single-record document tree, is inserted at time t1 (401). The method stores t1 in the XML indicator column 204 of the base table row referencing Doc ID=1 (402). In the inserted XML record, the method sets the start timestamp 211 to t1 and the end timestamp 212 to ‘FFFFFFFF’, representing infinity (403). In the Node ID index entry 501 for the XML record, the method stores t1 as the start timestamp 502 and ‘FFFFFFFF’ as the end timestamp 503 (404).

Referring to both FIGS. 4 and 5B, another XML document with Doc ID=2, a three-record document tree, is inserted at time t1 (401). The method stores t1 in the XML indicator column 204 of the base table row referencing Doc ID=2 (402). In each inserted XML record (Records r2 and r3), the method sets the start timestamp 211 to t1 and the end timestamp 212 to ‘FFFFFFFF’ (403). In the Node ID index entries 505-508, the method stores t1 as the start timestamp 512 and stores ‘FFFFFFFF’ as the end timestamp 511 in each entry 505-508 (404).

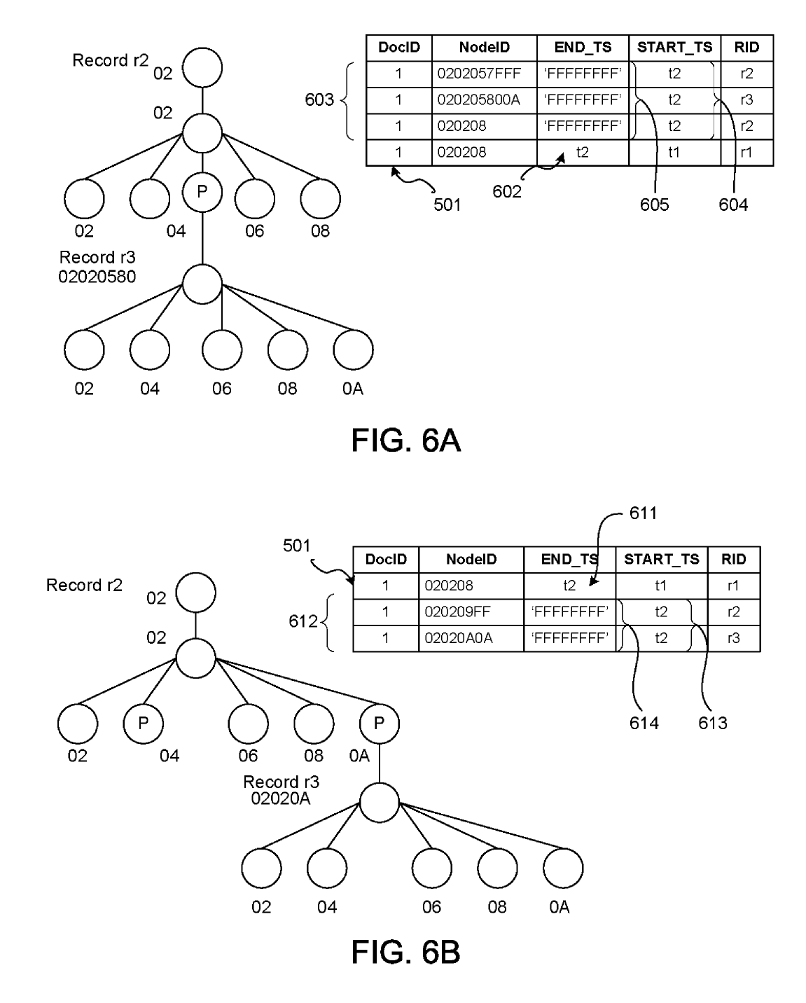

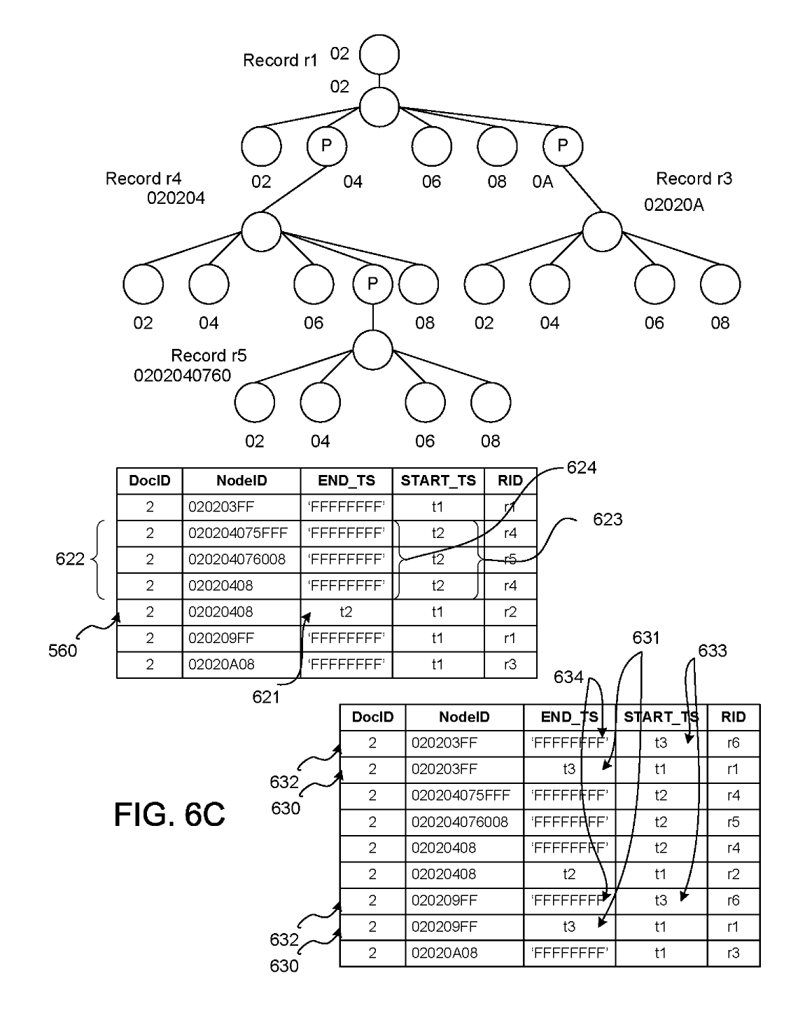

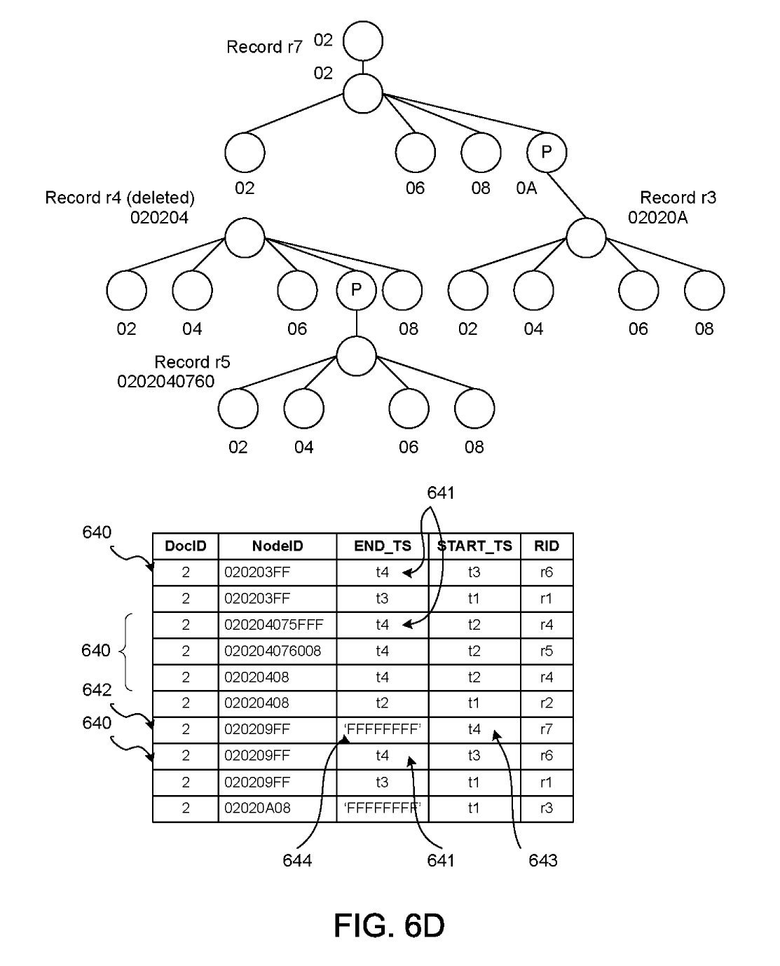

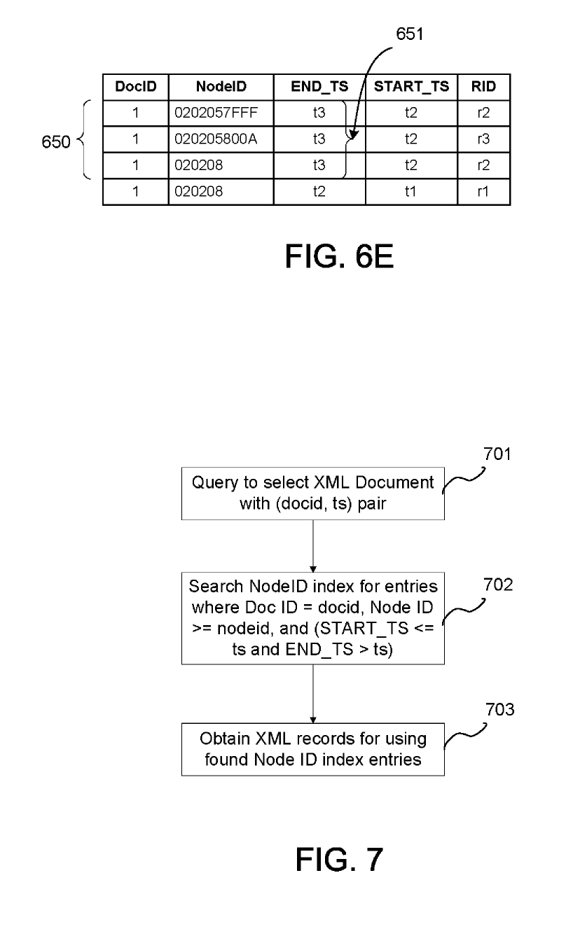

FIGS. 6A-6D illustrates examples of an update operation of an embodiment of the present invention. Referring to both FIGS. 4 and 6A and continuing with the example set forth in FIG. 5A, an XML document with Doc ID=1 is updated (410) by inserting a subtree between node 020204 and 020206 in a separate record (r3) at time t2. The existing record r1 is updated to become record r2, a new version of the XML document. The method sets the update timestamp 204 in the XML indicator column of the base table row referencing Doc ID=1 to t2 (411). For the replaced XML record r1, the method sets the end timestamp 212 to t2 (412). For the replacement XML records, r2 and r3, the method sets the start timestamp 211 to t2 and the end timestamp 212 to ‘FFFFFFFF’ (413). In the Node ID index entry for the replaced XML record r1 501, the method sets the end timestamp 602 to t2 (414). In the Node ID index entries for the replacement XML records 603, r2 and r3, the method sets the start timestamps 604 to t2 and the end timestamps 605 to ‘FFFFFFFF’ (415).

In FIG. 6B, the XML document with Doc ID=1 is updated (410) by inserting a subtree in a separate record (r3) at the end of the current tree at time t2. The validity of existing record (r1) will end at t2, and a new version (r2) will be created at t2. The method sets the update timestamp 204 in the XML indicator column of the base table row referencing Doc ID=1 to t2 (411). For the replaced XML record r1, the method sets the end timestamp 212 to t2 (412). For the replacement XML records, r2 and r3, the method sets the start timestamp 211 to t2 and the end timestamp 212 to ‘FFFFFFFF’ (413). In the Node ID index entry 610 for the replaced XML record r1, the method sets the end timestamp 611 to t2 (414). In the Node ID index entries 612 for the replacement XML records, r2 and r3, the method sets the start timestamps 613 to t2 and the end timestamps 614 to ‘FFFFFFFF’ (415).

Referring to both FIGS. 4 and 6C and continuing with the example set forth in FIG. 5B, the XML document with Doc ID=2 is updated (410) by inserting a subtree between nodes 02020406 and 02020408 in a separate record (r5) at t2. The record r2 is updated to become r4. The method sets the update timestamp 204 in the XML indicator column of the base table row referencing Doc ID=2 to t2 (411). For the replaced XML record r2, the method sets the end timestamp 212 to t2 (412). For the replacement XML records, r4 and r5, the method sets the start timestamp 211 to t2 and the end timestamp 212 to ‘FFFFFFFF’ (413). In the Node ID index entry 506 for the replaced XML record r2, the method sets the end timestamp 621 to t2 (414). In the Node ID index entries 622 for the replacement XML records, r4 and r5, the method sets the start timestamps 623 to t2 and the end timestamps 624 to ‘FFFFFFFF’ (415).

Continuing with the example illustrated in FIG. 6C, at time t3, the XML document is updated (410) on node 020206 in record r1, which becomes a new version record r6 (document tree not illustrated). The node tree does not change except r1 becomes r6 after t3. The method sets the update timestamp in the XML indicator column of the base table record referencing Doc ID=2 to t3 (411). For the replaced XML record r1, the method sets the end timestamp 212 to t3 (412). For the replacement XML record, r6, the method sets the start timestamp 211 to t3 and the end timestamp 212 to ‘FFFFFFFF’ (413). In the Node ID index entries 630 for the replaced XML record r1, the method sets the end timestamp 631 to t3 (414). In the Node ID index entry 632 for the replacement XML record, r6, the method sets the start timestamps 633 to t3 and the end timestamps 634 to ‘FFFFFFFF’ (415).

Continuing with the example illustrated in FIG. 6C, in FIG. 6D, the XML document with Doc ID=2 is updated (410) at time t4 by deleting node 020204, and the two records, r4 and r5 are deleted (420). The record r6 has a new version r7. The method sets the update timestamp in the XML indicator column of the base table row referencing Doc ID=2 to t4 (411). For the replaced XML records, r4, r5, and r6, the method sets the end timestamp 212 to t4 (412). For the replacement XML record, r7, the method sets the start timestamp 211 to t4 and the end timestamp 212 to ‘FFFFFFFF’ (413). In the Node ID index entries 640 for the replaced XML records, r4, r5, and r6, the method sets the end timestamp 641 to t4 (414). In the Node ID index entry 642 for the replacement XML record, r7, the method sets the start timestamps 643 to t4 and the end timestamps 644 to ‘FFFFFFFF’ (415).

FIG. 6E illustrates an example of a delete operation of an embodiment of the present invention. Referring to both FIGS. 4 and 6E and continuing with the example illustrated in FIG. 6A, the XML document with Doc ID=1 is deleted at time t3 (420). The method deletes the base table row referencing Doc ID=1 (421). The method sets the end timestamp in the XML records of the deleted XML document to t3 (422). In the Node ID index entries 650 for the XML records of the deleted XML document, the method sets the end timestamps 651 to t3 (423).

FIG. 7 is a flowchart illustrating a select operation to obtain a version of an XML document of an embodiment of the present invention. In this embodiment, a query to select a logical version of an XML document is received (701). The query includes a Doc ID and timestamp pair (docid, ts). In this embodiment, the timestamp ‘ts’ is obtained from the XML indicator column in the base table row referencing ‘docid’ and represents a version timestamp. The method searches the Node ID index for entries where Doc ID=docid, Node ID>=nodeid, and (START_TS<=ts and END_TS>ts) (702). The XML records for the version of the XML document is then obtained using the found Node ID index entries (705).

For example, the method begins the search of Node ID index entries with the search key (DocID=docid, NodeID=0, START_TS<=ts and END_TS>ts), which returns the root record of the XML document with Doc ID=docid with the validity period defined by the start and end timestamps. The root record is traversed, and the method determines if the XML document contains additional XML records. In response to determining that there are additional XML records, the method searches the Node ID index for an entry with a new nodeid value. This search key (docid, nodeid, START_TS<=ts and END_TS>ts) is then used to find another XML record. This search is repeated until all the XML records for the XML document is fetched and traversed. These XML records are then returned as a particular version of the XML document.

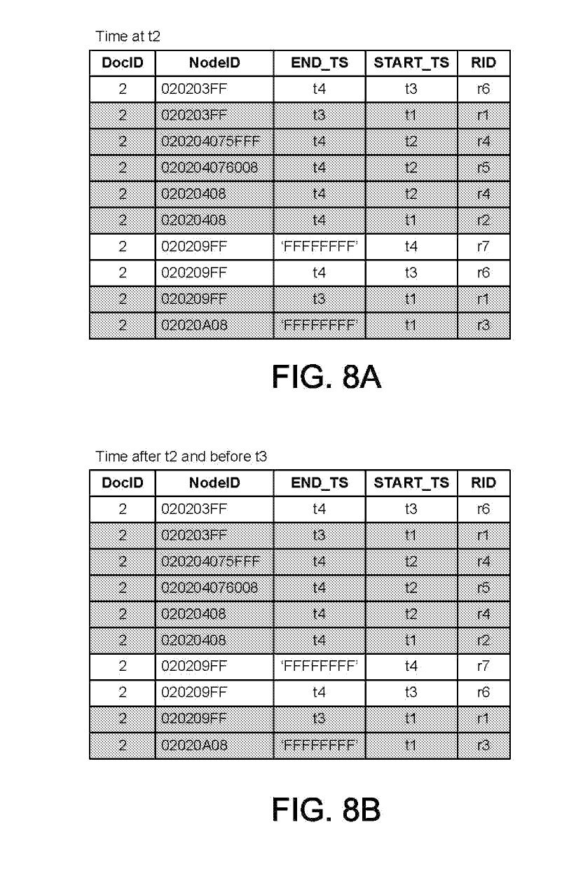

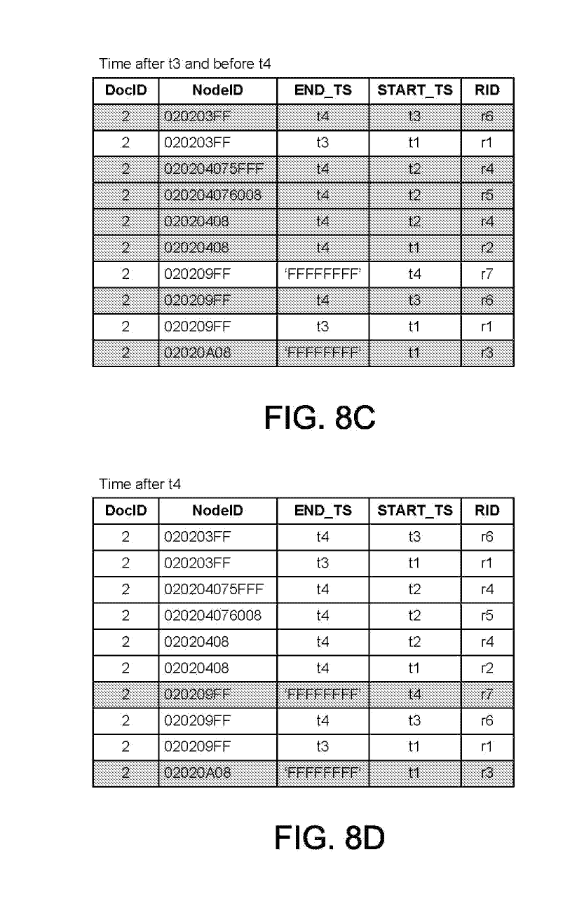

FIGS. 8A-8D illustrate an example of the select operation of an embodiment of the present invention. Continuing with the example illustrated in FIG. 6C, assume that a query to select a logical version of an XML document is received (701), and the query includes (docid=2, ts=t2) pair. The method searches the Node ID index for entries where Doc ID=2, Node ID>=0, and (START_TS<=t2 and END_TS>t2) (702). FIG. 8A illustrates the Node ID index entries (shaded) found for this example. The method obtains the XML records using the found Node ID index entries (703) using known methods.

Continuing with the example in FIG. 8A, FIG. 8B illustrates the Node ID index entries (shaded) found for a time after t2 and before t3. FIG. 8C illustrates the Node ID index entries (shaded) found for a time after t3 and before t4. FIG. 8D illustrates the Node ID index entries (shaded) found for a time after t4.

With the embodiment of the method of the present invention, several features may be supported, including but not limited to: last committed read feature, snapshot semantics, current version only feature, select from old data for update and delete feature, converting from non-versioning formats, and the purging of old versions and deleted data.

For the last committed read feature, when a current base table row is locked for an update, a last committed version may be found using the method of the present invention with a valid Doc ID and timestamp. The select operation described above may be used to find the corresponding XML document version. A reader of XML data need not wait for the update to complete before reading the XML document data that was committed.

For the snapshot semantics feature, a query timestamp is used to obtain the XML records instead of a stored timestamp. Using the Doc ID and the query timestamp, the select operation described above may obtain a snapshot of the XML document at the given timestamp.

For the current version only feature, utilities (such as REORG, CHECK DATA, CHECK INDEX, and REBUILD INDEX, each known in the art) may ignore old versions and focus on the current version only by checking only those records with the end timestamp=‘FFFFFFFF’.

For the selection from old data for update and delete feature, the method supports versioning of deleted XML data, so that the deleted XML data may be read back. To select old XML data, the old update timestamp from the base table row is maintained, i.e., multi-versioning of the base table is provided. The method then uses the (Doc ID, old update timestamp) pair in the select operation described above to obtain the old version of the XML document which contains the deleted XML data.

For the converting from non-versioning format feature, when converting from a non-versioning format to the versioning format supported by the method of the present invention, a zero timestamp, a timestamp at the time of conversion, or a default timestamp can be used to fill both the base table row update timestamp and the start timestamp in the Node ID index entries and XML records. Further, the end timestamps can be filled with “FFFFFFFF’ or a default.

For the purging of old versions and deleted data feature, if no one is reading a version older than timestamp ts, the records with an end timestamp <=ts can be deleted. More specifically, after a delete operation or an update operation logically deletes XML records by setting the end timestamp=CTS, the XML records can be purged when both of the following criteria are met: (1) the delete or update operation have been committed; and (2) there are no deferred fetches or readers that still need the logically deleted XML records.

Concerning criteria (1), until the delete or update operation has been committed, these operations may be rolled back. The XML records thus cannot be purged until it is known that the XML records will not be needed for rollback operations. To determine whether the delete or update operation has committed, a lock that is not compatible with a lock held by the delete or update operation can be acquired. However, since acquiring a lock is not efficient, the method may alternatively compare the end timestamp of the XML record with a ‘commit timestamp’ that is tracked for the XML table or for a larger scope. The commit timestamp is the timestamp of the oldest delete or update operation that has not committed. If the end timestamp value of a deleted XML record is older than (less than) the commit timestamp, then the delete or update operation has committed.

Concerning criteria (2), for a select operation, if the base table row was fetched to access the Doc ID and the XML indicator column value (update timestamp), but the XML records were not accessed immediately, the XML records need to persist even if the delete or update operation has logically deleted the version and committed. For the purpose of tracking the readers of XML data, when the base table row is fetched to access the Doc ID and the XML indicator column value, the timestamp for the reader is registered to track a ‘reader timestamp’. The reader timestamp is tracked for the XML table or for a larger scope. The reader timestamp is the timestamp of the oldest active reader with a read interest on the XML table. If the end timestamp value of the deleted XML record is older than (less than) the reader timestamp, then there are no readers that need to read the logically deleted XML record.

In determining if criteria (1) and (2) are met, the lesser of the commit timestamp and the reader timestamp are used to find XML records to purge. When the end timestamp value is less than the lesser of the commit timestamp and the reader timestamp, the XML record may be purged.

In this embodiment of the method of the present invention, a separate background task may be used to perform the actual purging of the XML records. When a delete operation or update operation occurs, the method provides the background task with information needed to purge XML records at a later time. This includes the end timestamp value used for the delete or update operation and information about the XML column that has XML records that were logically deleted. The lowest end timestamp value is kept for the background task. In response to the lowest end timestamp value being less than the lesser of the commit timestamp and the reader timestamp, the background task fetches XML records and determines whether the XML record is to be purged. When the end timestamp value of the XML record that is fetched is less than the lesser of the commit timestamp and the reader timestamp, the background task purges the XML record.

This feature may be helpful for a database reorganization (REORG) utility in reorganizing XML data. The REORG utility may compare the lesser of the commit timestamp and the reader timestamp with the XML record's end timestamp value. In response to the end timestamp value being lower, the REORG utility purges the XML records.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for multi-versioning data of a hierarchically structured document stored in a plurality of data records of a relational database system, comprising:
changing document data in one or more data records of the plurality of data records, each data record assigned a record identifier, the data record comprising a plurality of nodes assigned a node identifier, and the hierarchically structured document assigned a document identifier;
storing an update timestamp in a base table row referencing the document identifier;
storing in each changed data record a start timestamp for a start of a validity period for the changed data record and an end timestamp for an end of the validity period; and
storing the start timestamp and the end timestamp in one or more node identifier index entries referencing the document identifier, the record identifier, and the node identifier.

2. The method of claim 1, wherein the changing the document data in the one or more data records of the plurality of data records comprises: inserting the one or more data records into the plurality of data records;
wherein the storing the update timestamp in the base table row referencing the document identifier comprises: storing a current timestamp comprising a time of the inserting in the base table row referencing the document identifier;
wherein the storing in each changed data record the start timestamp for the start of the validity period for the changed data record and the end timestamp for the end of the validity period comprises: storing in each inserted data record the current timestamp as the start timestamp and a large value as the end timestamp; and
wherein the storing the start timestamp and the end timestamp in the one or more node identifier index entries referencing the document identifier, the record identifier, and the node identifier comprises: storing the current timestamp as the start timestamp and the large value as the end timestamp in the one or more node identifier index entries referencing the document identifier, the record identifier, and the node identifier.

3. The method of claim 1, wherein the changing the document data in the one or more data records of the plurality of data records comprises: updating the one or more data records of the plurality of data records;
wherein the storing the update timestamp in the base table row referencing the document identifier comprises: storing a current timestamp comprising a time of the updating in the base table row referencing the document identifier;
wherein the storing in each changed data record the start timestamp for the start of the validity period for the changed data record and the end timestamp for the end of the validity period comprises:
for each data record replaced in the updating, storing in the replaced data record the current timestamp as the end timestamp, and
for each replacement data record in the updating, storing in the replacement data record the current timestamp as the start timestamp and a large value as the end timestamp; and
wherein the storing the start timestamp and the end timestamp in the one or more node identifier index entries referencing the document identifier, the record identifier, and the node identifier comprises:
for each data record replaced in the updating, storing the current timestamp as the end timestamp in one or more node identifier index entries referencing the document identifier, a record identifier assigned to the replaced data record, and a node identifier assigned to the replaced data record, and
for each replacement data record in the updating, inserting one or more new node identifier index entries referencing the document identifier, a record identifier assigned to the replacement data record, and a node identifier assigned to the replacement data record, and storing the current timestamp as a start timestamp and the large value as an end timestamp in the one or more new node identifier index entries.

4. The method of claim 1, wherein the changing the document data in the one or more data records of the plurality of data records comprises: deleting the hierarchically structured document;
wherein the storing the update timestamp in the base table row referencing the document identifier comprises: deleting the base table row referencing the document identifier;
wherein the storing in each changed data record the start timestamp for the start of the validity period for the changed data record and the end timestamp for the end of the validity period comprises: storing in each data record of the deleted hierarchically structured document a current timestamp comprising a time of the deleting as the end timestamp; and
wherein the storing the start timestamp and the end timestamp in the one or more node identifier index entries referencing the document identifier, the record identifier, and the node identifier comprises: storing the current timestamp as the end timestamp in the one or more node identifier index entries for each data record of the deleted hierarchically structured document.

5. The method of claim 1, further comprising:
receiving a query to select a version of the hierarchically structured document, the query comprising the document identifier and a version timestamp;
searching the node identifier index for one or more entries referencing the document identifier and the node identifier, wherein the start timestamp of the entry is less than or equal to the version timestamp and the end timestamp of the entry is greater than the version timestamp;
obtaining one or more data records for the version of the hierarchically structured document using the found node identifier entries; and
returning the obtained data records.

6. The method of claim 5, wherein the receiving the query to select the version of the hierarchically structured document comprises:
obtaining the version timestamp from the update timestamp in the base table row referencing the document identifier.

7. The method of claim 5, wherein the receiving the query to select the version of the hierarchically structured document comprises:
obtaining the version timestamp from a timestamp for the query.

8. A computer program product for multi-versioning data of a hierarchically structured document stored in a plurality of data records of a relational database system, the computer program product comprising:
a computer readable storage medium having computer readable program code embodied therewith, the computer readable program code configured to:
change document data in one or more data records of the plurality of data records, each data record assigned a record identifier, the data record comprising a plurality of nodes assigned a node identifier, and the hierarchically structured document assigned a document identifier;
store an update timestamp in a base table row referencing the document identifier;
store in each changed data record a start timestamp for a start of a validity period for the changed data record and an end timestamp for an end of the validity period; and
store the start timestamp and the end timestamp in one or more node identifier index entries referencing the document identifier, the record identifier, and the node identifier.

9. The computer program product of claim 8, wherein the computer readable program code configured to change the document data in the one or more data records of the plurality of data records is further configured to: insert the one or more data records into the plurality of data records;
wherein the computer readable program code configured to store the update timestamp in the base table row referencing the document identifier is further configured to: store a current timestamp comprising a time of the inserting in the base table row referencing the document identifier;
wherein the computer readable program code configured to store in each changed data record the start timestamp for the start of the validity period for the changed data record and the end timestamp for the end of the validity period is further configured to: store in each inserted data record the current timestamp as the start timestamp and a large value as the end timestamp; and
wherein the computer readable program code configured to store the start timestamp and the end timestamp in the one or more node identifier index entries referencing the document identifier, the record identifier, and the node identifier is further configured to: store the current timestamp as the start timestamp and the large value as the end timestamp in the one or more node identifier index entries referencing the document identifier, the record identifier, and the node identifier.

10. The computer program product of claim 8, wherein the computer readable program code configured to change the document data in the one or more data records of the plurality of data records is further configured to: update the one or more data records of the plurality of data records;
wherein the computer readable program code configured to store the update timestamp in the base table row referencing the document identifier is further configured to: store a current timestamp comprising a time of the updating in the base table row referencing the document identifier;
wherein the computer readable program code configured to store in each changed data record the start timestamp for the start of the validity period for the changed data record and the end timestamp for the end of the validity period is further configured to:
for each data record replaced in the update, store in the replaced data record the current timestamp as the end timestamp, and
for each replacement data record in the update, store in the replacement data record the current timestamp as the start timestamp and a large value as the end timestamp; and
wherein the computer readable program code configured to store the start timestamp and the end timestamp in the one or more node identifier index entries referencing the document identifier, the record identifier, and the node identifier is further configured to:
for each data record replaced in the update, store the current timestamp as the end timestamp in the one or more node identifier index entries referencing the document identifier, a record identifier assigned to the replaced data record, and a node identifier assigned to the replaced data record, and
for each replacement data record in the update, insert one or more new node identifier index entries referencing the document identifier, a record identifier assigned to the replacement data record, and a node identifier assigned to the replacement data record, and storing the current timestamp as a start timestamp and the large value as an end timestamp in the one or more new node identifier index entries.

11. The computer program product of claim 8, wherein the computer readable program code configured to change the document data in the one or more data records of the plurality of data records is further configured to: delete the hierarchically structured document;
wherein the computer readable program code configured to store the update timestamp in the base table row referencing the document identifier is further configured to: delete the base table row referencing the document identifier;
wherein the computer readable program code configured to store in each changed data record the start timestamp for the start of the validity period for the changed data record and the end timestamp for the end of the validity period is further configured to: store in each data record of the deleted hierarchically structured document a current timestamp comprising a time of the deleting as the end timestamp; and
wherein the computer readable program code configured to store the start timestamp and the end timestamp in the one or more node identifier index entries referencing the document identifier, the record identifier, and the node identifier is further configured to: store the current timestamp as the end timestamp in the one or more node identifier index entries for each data record of the deleted hierarchically structured document.

12. The computer program product of claim 8, wherein the computer readable program code is further configured to:
receive a query to select a version of the hierarchically structured document, the query comprising the document identifier and a version timestamp;
search the node identifier index for one or more entries referencing the document identifier and the node identifier, wherein the start timestamp of the entry is less than or equal to the version timestamp and the end timestamp of the entry is greater than the version timestamp;
obtain one or more data records for the version of the hierarchically structured document using the found node identifier entries; and
return the obtained data records.

13. The computer program product of claim 12, wherein the computer readable program code configured to receive the query to select the version of the hierarchically structured document is further configured to:
obtain the version timestamp from the update timestamp in the base table row referencing the document identifier.

14. The computer program product of claim 12, wherein the computer readable program code configured to receive the query to select the version of the hierarchically structured document is further configured to:
obtain the version timestamp from a timestamp for the query.

15. A system, comprising:
a relational database system comprising a hierarchically structured document stored in a plurality of data records of the relational database system; and
a computer comprising a computer readable storage medium having computer readable program code embodied therewith, the computer readable program code configured to:
change document data in one or more data records of the plurality of data records, each data record assigned a record identifier, the data record comprising a plurality of nodes assigned a node identifier, and the hierarchically structured document assigned a document identifier;
store an update timestamp in a base table row referencing the document identifier;
store in each changed data record a start timestamp for a start of a validity period for the changed data record and an end timestamp for an end of the validity period; and
store the start timestamp and the end timestamp in one or more node identifier index entries referencing the document identifier, the record identifier, and the node identifier.

16. The system of claim 15, wherein the computer readable program code configured to change the document data in the one or more data records of the plurality of data records is further configured to: insert the one or more data records into the plurality of data records;
wherein the computer readable program code configured to store the update timestamp in the base table row referencing the document identifier is further configured to: store a current timestamp comprising a time of the inserting in the base table row referencing the document identifier;
wherein the computer readable program code configured to store in each changed data record the start timestamp for the start of the validity period for the changed data record and the end timestamp for the end of the validity period is further configured to: store in each inserted data record the current timestamp as the start timestamp and a large value as the end timestamp; and
wherein the computer readable program code configured to store the start timestamp and the end timestamp in the one or more node identifier index entries referencing the document identifier, the record identifier, and the node identifier is further configured to: store the current timestamp as the start timestamp and the large value as the end timestamp in the one or more node identifier index entries referencing the document identifier, the record identifier, and the node identifier.

17. The system computer program product of claim 15, wherein the computer readable program code configured to change the document data in the one or more data records of the plurality of data records is further configured to: update the one or more data records of the plurality of data records;
wherein the computer readable program code configured to store the update timestamp in the base table row referencing the document identifier is further configured to: store a current timestamp comprising a time of the updating in the base table row referencing the document identifier;
wherein the computer readable program code configured to store in each changed data record the start timestamp for the start of the validity period for the changed data record and the end timestamp for the end of the validity period is further configured to:
for each data record replaced in the update, store in the replaced data record the current timestamp as the end timestamp, and
for each replacement data record in the update, store in the replacement data record the current timestamp as the start timestamp and a large value as the end timestamp; and
wherein the computer readable program code configured to store the start timestamp and the end timestamp in the one or more node identifier index entries referencing the document identifier, the record identifier, and the node identifier is further configured to:
for each data record replaced in the update, store the current timestamp as the end timestamp in the one or more node identifier index entries referencing the document identifier, a record identifier assigned to the replaced data record, and a node identifier assigned to the replaced data record, and
for each replacement data record in the update, insert one or more new node identifier index entries referencing the document identifier, a record identifier assigned to the replacement data record, and a node identifier assigned to the replacement data record, and storing the current timestamp as a start timestamp and the large value as an end timestamp in the one or more new node identifier index entries.

18. The system of claim 15, wherein the computer readable program code configured to change the document data in the one or more data records of the plurality of data records is further configured to: delete the hierarchically structured document;
wherein the computer readable program code configured to store the update timestamp in the base table row referencing the document identifier is further configured to: delete the base table row referencing the document identifier;
wherein the computer readable program code configured to store in each changed data record the start timestamp for the start of the validity period for the changed data record and the end timestamp for the end of the validity period is further configured to: store in each data record of the deleted hierarchically structured document a current timestamp comprising a time of the deleting as the end timestamp; and
wherein the computer readable program code configured to store the start timestamp and the end timestamp in the one or more node identifier index entries referencing the document identifier, the record identifier, and the node identifier is further configured to: store the current timestamp as the end timestamp in the one or more node identifier index entries for each data record of the deleted hierarchically structured document.

19. The system of claim 15, wherein the computer readable program code is further configured to:
receive a query to select a version of the hierarchically structured document, the query comprising the document identifier and a version timestamp;
search the node identifier index for one or more entries referencing the document identifier and the node identifier, wherein the start timestamp of the entry is less than or equal to the version timestamp and the end timestamp of the entry is greater than the version timestamp;
obtain one or more data records for the version of the hierarchically structured document using the found node identifier entries; and
return the obtained data records.

20. The system of claim 19, wherein the computer readable program code configured to receive the query to select the version of the hierarchically structured document is further configured to:
obtain the version timestamp from the update timestamp in the base table row referencing the document identifier.
